(19) United States
(12) Patent Application Publication
(10) Pub. No.: US 2022/0398673 A1
(43) Pub. Date: Dec. 15, 2022

(54) Automatic Machine-to-Machine (M2M) Communications Based on Machine Learning

(71) Applicant: Bank of America Corporation, Charlotte, NC (US)

(72) Inventors: Pratap Dande, Saint Johns, FL (US); Robert Nyeland Huggins, Charlotte, NC (US); Jinna Zevulun Kim, Charlotte, NC (US); Brandon Sloane, Indian Land, SC (US); Vijaya L. Vemireddy, Plano, TX (US); Siten Sanghvi, Westfield, NJ (US)

(21) Appl. No.: 17/346,949

(22) Filed: Jun. 14, 2021

(51) Int. Cl. G06Q 40/00; G06N 20/00; G06Q 30/04

(52) U.S. Cl. CPC G06Q 40/125; G06N 20/00; G06Q 30/04

(57) ABSTRACT

A system includes memory operable to store instructions and processing circuitry operable to execute the instructions. The system accesses previous data processing transactions associated with a first account of a user, wherein at least one of the previous data processing transactions are transacted using a first routing between a first computing system and a second computing system. The system further determines, using machine learning, a pattern from the previous data processing transactions and determines an upcoming data processing transaction corresponding to the pattern. The system further compares the upcoming data processing transaction to a data item associated with the first account and determines a second routing between the second computing system and a third computing system. The system further transacts, based on the comparison of the upcoming data processing transaction to the data item, the upcoming data processing transaction using either the first routing or the second routing.

### TECHNICAL FIELD

Certain embodiments of the present disclosure relate to machine-to-machine (M2M) communications, and more particularly to automatic M2M communications based on machine learning.

### BACKGROUND

A computer may use machine learning to automatically improve how the computer performs a task. Machine learning may involve analyzing data in order to make predictions or decisions associated with performing the task, without requiring a user to explicitly program the computer to perform the task. Machine learning may be used in a wide variety of applications, such as applications where it is difficult for a user to develop computer code to perform the needed tasks.

### SUMMARY

A computer may use machine learning to automatically improve how the computer performs a task. Machine learning may involve analyzing data in order to make predictions or decisions associated with performing the task, without requiring a user to explicitly program the computer to perform the task. Machine learning may be used in a wide variety of applications, such as applications where it is difficult for a user to develop computer code to perform the needed tasks. This disclosure contemplates utilizing machine learning to facilitate automatic machine-to-machine (M2M) communications. For example, in certain embodiments, a computer determines how to route a data processing operation between two computers systems based on machine learning.

According to certain embodiments, a system includes memory operable to store instructions and processing circuitry operable to execute the instructions. The system accesses previous data processing transactions associated with a first account of a user, wherein at least one of the previous data processing transactions are transacted using a first communications channel between a first computing system and a second computing system. The system further determines, using machine learning, a pattern from the previous data processing transactions and determines an upcoming data processing transaction corresponding to the pattern. The system further compares the upcoming data processing transaction to a data item associated with the first account and determines a second communications channel between the second computing system and a third computing system. The system further transacts, based on the comparison of the upcoming data processing transaction to the data item, the upcoming data processing transaction using a selected one of the first communications channel or the second communications channel.

According to certain embodiments, a method includes accessing previous data processing transactions associated with a first account of a user, wherein at least one of the previous data processing transactions are transacted using a first communications channel between a first computing system and a second computing system. The method further includes determining, using machine learning, a pattern from the previous data processing transactions and determines an upcoming data processing transaction corresponding to the pattern. The method further includes comparing the upcoming data processing transaction to a data item associated with the first account and determines a second communications channel between the second computing system and a third computing system. The method further includes transacting, based on the comparison of the upcoming data processing transaction to the data item, the upcoming data processing transaction using a selected one of the first communications channel or the second communications channel.

According to certain embodiments, a non-transitory computer readable medium comprises logic that, when executed by processing circuitry, causes the processing circuitry to perform actions. The actions include accessing previous data processing transactions associated with a first account of a user, wherein at least one of the previous data processing transactions are transacted using a first communications channel between a first computing system and a second computing system. The actions further include determining, using machine learning, a pattern from the previous data processing transactions and determines an upcoming data processing transaction corresponding to the pattern. The actions further include comparing the upcoming data processing transaction to a data item associated with the first account and determines a second communications channel between the second computing system and a third computing system. The actions further include transacting, based on the comparison of the upcoming data processing transaction to the data item, the upcoming data processing transaction using a selected one of the first communications channel or the second communications channel.

Embodiments of the present disclosure provide technological solutions to technological problems. For example, in certain embodiments, a computer determines how to route a data processing operation based on machine learning. The machine learning may allow for more efficient routing of data processing operations. Routing data processing operations more efficiently may facilitate faster processing of the data processing operation. Routing data processing operations more efficiently may facilitate efficient use of computing resources, such as network resources, processing resources, or memory resources. As an example, by routing a data processing operation more efficiently, certain embodiments may allow for reducing messaging involved in performing the data processing operation, which may allow for reducing the computing resources required to perform the data processing operation. Other technical advantages of the present disclosure will be readily apparent to one skilled in the art from the following figures, descriptions, and claims. Moreover, while specific advantages have been enumerated above, various embodiments may include all, some, or none of the enumerated advantages.

### BRIEF DESCRIPTION

For a more complete understanding of the present disclosure and for further features and advantages thereof, reference is now made to the following description taken in conjunction with the accompanying example drawings, in which:

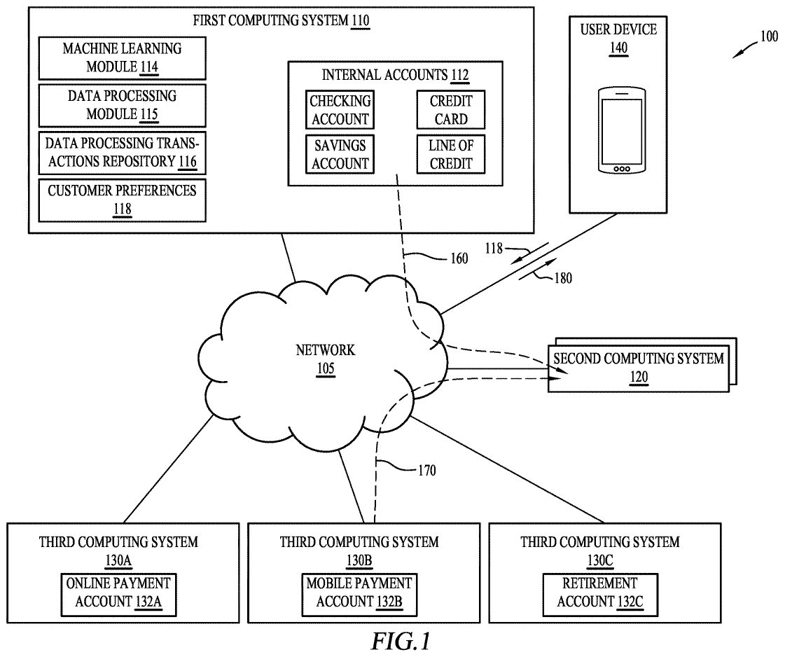

FIG. 1 is a schematic diagram of an example system for automatic machine-to-machine (M2M) communications based on machine learning, according to certain embodiments;

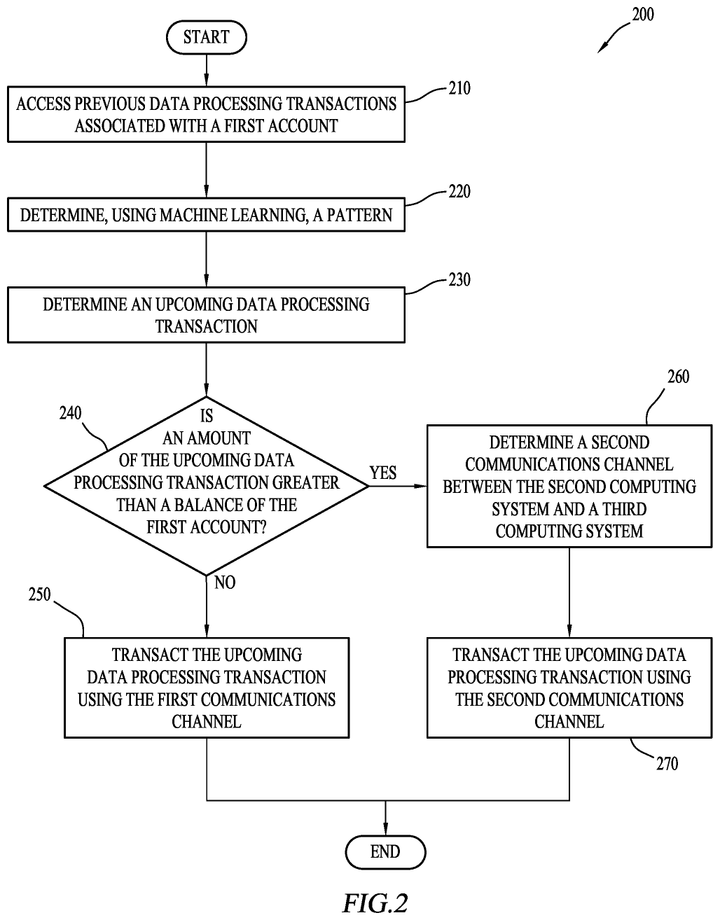

FIG. 2 is a flowchart of a method for automatic M2M communications based on machine learning, according to certain embodiments; and

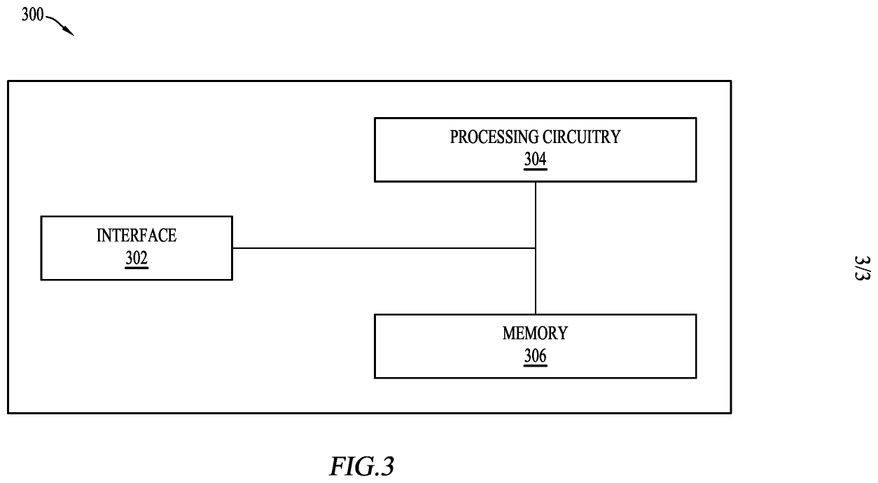

FIG. 3 illustrates an example of computing components, according to certain embodiments.

### DETAILED DESCRIPTION

Certain embodiments of the present disclosure may be implemented in accordance with one or more of FIGS. 1-3, like numerals used to describe like components of the various figures.

FIG. 1 illustrates an example of an automatic M2M communications system 100, in accordance with certain embodiments. According to certain embodiments, automatic M2M communications system 100 includes a network 105 that facilitates communication among one or more user devices 140, one or more first computing systems 110, one or more second computing systems 120, and/or one or more third computing systems 130. In general, first computing system 110 obtains historical data associated with a plurality of previous data processing transactions transacted using a first M2M communications channel 160 between first computing system 110 and at least one second computing system 120, uses machine learning (e.g., machine learning module 114) to determine a pattern based on the historical data, and determines an upcoming data processing transaction corresponding to the pattern. First computing system 110 then compares the upcoming data processing transaction to an internal account 112, determines a second M2M communications channel 170 between the second computing system 120 and a third computing system 130, and uses a selected one of first M2M communications channel 160 or second M2M communications channel 170 based on the comparison to transact the upcoming data processing transaction.

Network 105 represents any suitable network(s) operable to facilitate communication between user devices 140, one or more first computing systems 110, one or more second computing systems 120, and/or one or more third computing systems 130. Network 105 may include any interconnecting system capable of transmitting audio, video, signals, data, messages, or any combination of the preceding. Network 105 may include all or a portion of a public switched telephone network (PSTN), a cellular network, a base station, a gateway, a public or private data network, a local area network (LAN), a metropolitan area network (MAN), a wide area network (WAN), a wireless WAN (WWAN), a local, regional, or global communication or computer network, such as the Internet, a wireline or wireless network, an enterprise intranet, or any other suitable communication link, including combinations thereof, operable to facilitate communication between the components.

Each of the computing systems (e.g., first computing system 110, second computing system 120, and third computing system 130) may include hardware and/or software capable of communicating with each other and/or user device 140 via network 105. Examples of a computing system may include one or more servers (e.g., cloud-based servers, file servers, web servers, etc.), data centers, virtual machines, mainframe computers, etc. In certain embodiments, the different computing systems are each associated with a respective enterprise (such as a business or company). For example, first computing system 110 may be associated with a financial institution (e.g., a bank) where the customer maintains a financial account (i.e., internal accounts 112) such as a checking or savings account. Second computing system 120 may be associated with a different enterprise with which first computing system 110 performs data processing transactions. As a specific example, second computing systems 120 may each be associated with a vendor or company to which first computing system 110 sends funds on behalf of a user (e.g., bill pay transactions). Third computing system 130 may be associated with any institution that is separate from first computing system 110 and that offers financial services to the customer. As a specific example, each third computing system 130 (e.g., 130A-130C) may hold various external accounts 132 (e.g., an online payment account 132A such as PayPal, a mobile payment account 132B such as Venmo, and a retirement account 132C in the name of the user). In addition to external accounts 132 illustrated in FIG. 1, external account 132 may be any other external account owned by the customer (e.g., a digital wallet, a cryptocurrency holding, a credit card, a checking account, a savings account, a line of credit such as HELOC, or any other liquid asset). In some embodiments, third computing system 130 may alternatively be an external trusted account (e.g., a Venmo account owned by a parent of the customer).

User device 140 generally refers to a computing device that can be used by the user to interact with first computing system 120 and/or second computing system 160 via network 105. Examples include a workstation, a personal computer, a laptop, a tablet computer, a phone, a smartphone, a smartwatch, a handheld device, a wireless device, etc.

First and second M2M communication channels 160 and 170 are any suitable communication channels that facilitate transacting a data processing transaction between first computing system 110, second computing system 120, and third computing system 130. In certain embodiments, first and second M2M communication channels 160 and 170 are direct communication channels or point-to-point communication channels. In certain embodiments, first and second M2M communication channels 160 and 170 are dedicated communication channels. In certain embodiments, first and second M2M communication channels 160 and 170 are a virtual private network (VPN), a software-defined WAN (SD-WAN), or a Secure Access Service Edge (SASE). In other embodiments, first and second M2M communication channels 160 and 170 are simply any suitable portion of network 105 that facilitates communication between first computing system 110, second computing system 120, and third computing system 130.

In certain embodiments, first computing system 110 includes a data processing module 115, a data processing transactions repository 116, and a machine learning module 114. In general, data processing module 115 transacts data processing transactions, data processing transactions repository 116 stores data processing transactions (including, e.g., historical data such as prior transactions), and machine learning module 114 determines a pattern based at least in part on the historical data. The operation of machine learning module 114 is described in more detail below.

For purposes of example and explanation, FIG. 1 depicts the network as including certain components. However, this disclosure recognizes that the network may include any suitable components. One of ordinary skill in the art will appreciate that certain components can be omitted and other components not mentioned herein can be added. Additionally, components can be integrated or separated in any suitable manner. Functionality described in FIG. 1 can be distributed or localized in any suitable manner. For simplicity, FIG. 1 depicts one of each component. Other embodiments may include multiples of one or more components. As an example, system 100 may include multiple user devices 140. Certain user devices 140 may be associated with the same user, such as the user's personal computer and the user's smartphone. Certain user devices 140 may be associated with different users. For example, first computing system 110 may monitor data processing transactions associated with other users, determine patterns, make recommendations to the other users based on the patterns, etc. As another example, system 100 may include multiple second computing systems 120 (e.g., different second computing systems 120 may be associated with different enterprises with which first computing system 110 performs data processing transactions).

In certain specific embodiments, automatic M2M communications system 100 may be used to facilitate automatic recurring bill payments from a customer to a vendor. The vendor could be a business, such as a service provider (e.g., phone company, Internet service provider, utility company, subscription service provider, etc.), a vendor of goods, etc. In this example, first computing system 110 may be associated with a financial institution, such as a bank where the customer maintains one or more internal accounts 112. The second computing system 120 may be associated with the vendor. Third computing system 130 may be associated with a separate institution where the customer maintains an external account 132 (e.g., Venmo or PayPal) that holds funds or credit for the customer. In this example, the customer may arrange for recurring bills to the vendor to be automatically paid from an internal account 112 (e.g., the customer's checking account). For example, the customer may arrange for their monthly phone bill of $75 to be automatically paid to their phone company on a certain date of the month from their checking account 112. In this scenario, the monthly data processing transaction for the phone bill (i.e., the transfer of $75 from checking account 112 to the phone company) may be transacted using first M2M communications channel 160 between first computing system 110 and a second computing system 120 of the phone company. However, if an available balance of internal checking account 112 is less than the recurring bill being paid, the data processing transaction between first computing system 110 and second computing system 120 may fail, resulting in a missed payment for the customer.

To address these and other problems, embodiments of the disclosure provide a solution that involves determining a pattern of recurring payments, determining an upcoming payment from the pattern, and then automatically transacting the upcoming payment using second M2M communications channel 170 when a balance of internal account 112 that is typically used to transact the payment is less than the upcoming payment. Using the above example of the upcoming recurring phone of $75 that is to be paid from internal checking account 112, if a balance of checking account 112 is less than $75, automatic M2M communications system 100 automatically selects a second M2M communications channel 170 between a third computing system 130 and second computing system 120 of the phone company to pay the upcoming bill instead of using first M2M communications channel 160 between first computing system 110 and second computing system 120. In the specific example illustrated in FIG. 1, automatic M2M communications system 100 may select second M2M communications channel 170 between third computing system 130B and second computing system 120 in order cover the upcoming bill using external mobile payment account 132B (e.g., Venmo).

In certain embodiments, machine learning module 114 may be utilized to determine a pattern within previous data processing transactions (e.g., previous bill payments) and then use the pattern to determine an upcoming data processing transaction (e.g., an upcoming bill payment). In some embodiments, machine learning module 114 may access historical data associated with previous data processing transactions (e.g., previous payments from internal accounts 112) stored in data processing transactions repository 116. As an example, machine learning module 114 may access historical data from payments across multiple internal accounts 112 (e.g., credit accounts, debit accounts, etc.), multiple vendors, etc. Machine learning module 114 may utilize rules-based predictive analytics and/or a regression engine to determine a pattern within the historical data and predict that the customer will be paying a particular amount to a particular vendor from a particular internal account 112 at a particular time (e.g., the 1^{st} day of next month). For example, machine learning module 114 may determine that the customer pays their phone bill of $75 from checking account 112 on the 1^{st} of every month. As another example, machine learning module 114 may determine that the customer pays the registration for their automobile around February 1^{st} of every year. In some embodiments, the determination of the upcoming data processing transaction may be based on any appropriate statistical analysis and pattern recognition technique.

In some embodiments, automatic M2M communications system 100 compares the determined upcoming data processing transaction (e.g., an upcoming bill to be paid) to a data item associated with internal account 112. In some embodiments, the data item may be a current balance of internal account 112 (e.g., a current amount of available funds in internal account 112). In other embodiments, the data item may be a predicted balance of internal account 112. For example, if the determined upcoming data processing transaction is a $75 bill to be paid in two weeks, the $75 bill may be compared to a predicted balance of internal account 112 in two weeks. In other embodiments, the data item may be a customer-indicated threshold of internal account 112. For example, the customer may indicate via customer preferences 118 that the lowest balance they desire for a particular internal account 112 is $100. In this scenario, the upcoming data processing transaction (e.g., the upcoming $75 bill) may be compared to a current balance of internal account 112 to determine if the upcoming data processing transaction will reduce the balance of internal account 112 below the customer-indicated threshold. In all of these embodiments, if the comparison indicates that the upcoming data processing transaction is greater than the data item associated with internal account 112, automatic M2M communications system 100 may take action to select a second M2M communications channel 170 for the upcoming data processing transaction.

In some embodiments, second M2M communications channel 170 may be a direct communications channel between third computing system 130 and second computing system 120. For example, automatic M2M communications system 100 may direct third computing system 130B to utilize external account 132B to directly transact an upcoming data processing transaction (e.g., automatic M2M communications system 100 may send instructions for an upcoming bill to be paid directly from external account 132B due to a shortage in internal account 112). In other embodiments, second M2M communications channel 170 may be different from that illustrated in FIG. 1. For example, second M2M communications channel 170 may flow between third computing system 130, first computing system 110, and second computing system 120. An example of this scenario would be that, due to a shortage in internal account 112, automatic M2M communications system 100 automatically transfers funds from external account 132B to a particular internal account 112 and then transfers funds from the particular internal account 112 to second computing system 120. In some embodiments, an Application Programming Interface (API) may be used for second M2M communications channel 170.

In another particular example to illustrate the operation of an embodiment of automatic M2M communications system 100, consider a business that owns a corporate checking account 112 that the business uses to make payroll (i.e., payroll transactions that occur along first M2M communications channel 160 between first computing system 110 and second computing systems 120 associated with accounts of the employees of the business). The business also owns an online payment account 132A at third computing system 130A and has provided first computing system 110 with access to the online payment account 132A. Automatic M2M communications system 100 may access and analyze previous data processing transactions associated with the corporate checking account 112 in order to determine a pattern and upcoming data processing transactions (e.g., analyze the payroll payments from prior months in order to determine a typical payroll amount and a payroll amount that will be due on a certain upcoming date). Automatic M2M communications system 100 may compare this payroll amount to a balance of corporate checking account 112 and determine that corporate checking account 112 will have an insufficient amount to cover the upcoming payroll. To avoid this situation, automatic M2M communications system 100 may make some or all of the upcoming payroll transactions using second M2M communications channel 170 between third computing system 130A and second computing systems 120 (i.e., payroll transactions occur along first second M2M communications channel 170 between online payment account 132A and second computing systems 120 associated with accounts of the employees of the business). As a result, funds are automatically transferred from an appropriate account in order to cover the anticipated payroll for the business.

In some embodiments, a customer provides customer preferences 118 to be used by automatic M2M communications system 100. For example, a customer may provide an initial approval for automatic M2M communications system 100 to perform the operations described herein. After the approval is provided by the customer, automatic M2M communications system 100 may automatically determine that an internal account 112 will not have a sufficient amount to cover an upcoming data processing transaction and select a third computing system 130 with which to perform the upcoming data processing transaction (e.g., a future online payment to a vendor may be transacted via a second M2M communications channel 170 between the selected third computing system 130 and second computing system 120 of the vendor).

In some embodiments, customer preferences 118 may include a preferred order of the customer for selecting which third computing system 130 to use to cover an upcoming data processing transaction if an internal account 112 does not have a sufficient amount to cover the upcoming data processing transaction. For example, the customer may indicate via customer preferences 118 a preferred order of: first use external online payment account 132A, second use external mobile payment account 132B, and third use external retirement account 132C. In the absence of a preferred order of third computing systems 130 from the customer, automatic M2M communications system 100 may utilize any appropriate logic to select which third computing system 130 to use. As one example, automatic M2M communications system 100 may utilize logic that considers the following factors when selecting a particular third computing system 130: the balance impact of a transfer from a checking or savings account; potential tax effects of selling an investment holding; potential transaction or interest fees for a line of credit draw; potential points earning for using a particular credit card; and the like.

Certain embodiments may generate customer notifications 180 based on the operations described herein. In one example, automatic M2M communications system 100 may provide notification 180 via user device 140 to the customer that an internal account 112 will have an insufficient amount to cover an upcoming data processing transaction (e.g., an upcoming bill payment). The notification 180 may be a text message that reads, for example, “Your checking account will have not have enough to cover your upcoming phone bill of $75 due on February 1^{st} and will be automatically be paid via your linked Venmo account, ok?” The customer may then respond to the notification (e.g., via reply text) in order to approve the transaction. In another example, notification 180 may seek the customers input about which third computing system 130 to use for an upcoming data processing transaction. For example, notification 180 may be a text message that reads “Your checking account will have not have enough to cover your upcoming phone bill of $75 due on February 1^{st}. Reply “1” to pay via your linked Venmo account. Reply “2” to pay via your linked PayPal account. Reply “3” to pay by selling stock from your linked retirement account.” The customer may then respond to the notification (e.g., via reply text) in order to select which third computing system 130 to use for the transaction.

In some embodiments, an automated loan may be offered to a customer if an internal account 112 does not have a sufficient amount to cover a data processing transaction. For example, consider a scenario where a customer is attempting to purchase an expensive item such as a television or refrigerator. Automatic M2M communications system 100 may detect that the internal account 112 that the customer is attempting to use does not have a sufficient amount to cover the purchase transaction and send a text notification 180 to the customer such as “We see your debit card was declined for this transaction. Reply “1” to accept a personal loan for the item.” The customer may then respond to the notification (e.g., via reply text) in order to approve the loan. In some embodiments, automatic M2M communications system 100 may determine whether to offer the automated loan to the customer based on a risk profile of the customer. For example, if a risk profile of the customer indicates that the customer is a risky borrower (e.g., the customer has a credit score below a certain threshold), automatic M2M communications system 100 may determine to not offer the automated loan. On the other hand, if a risk profile of the customer indicates that the customer is not a risky borrower (e.g., the customer has a credit score above a certain threshold), automatic M2M communications system 100 may determine to offer the automated loan.

FIG. 2 illustrates an example of a method 200 for automatic M2M communications based on machine learning that may be performed by a computing system, such as the first computing system 110 described with respect to FIG. 1. Method 200 may begin in step 210 where a plurality of previous data processing transactions associated with a first account of a user are accessed. In some embodiments, the previous data processing transactions are fund transfers from the first account such as automatic bill pay transactions. In some embodiments, the first account is an internal account 112. In some embodiments, the first computing system is associated with the first account of the user, and the first account is a checking or savings account. In some embodiments, the second computing system is associated with a second account of the user, the second account being an account of a bill to be paid. In some embodiments, the plurality of previous data processing transactions that are accessed in step 210 are stored in data processing transactions repository 116. At least one of the plurality of previous data processing transactions that are accessed in step 210 are transacted using a first communications channel between a first computing system and a second computing system. The first communication channel may be first M2M communications channel 160, and the second computing system may be second computing system 120.

At step 220, method 200 determines, using machine learning, a pattern from the plurality of previous data processing transactions accessed in step 210. In some embodiments, method 220 is performed by machine learning module 114. In some embodiments, the pattern includes a list of previous data processing transactions (e.g., previous bills paid), an amount associated with each previous data processing transaction (e.g., $75), and a date or frequency associated with each previous data processing transaction (e.g., paid on February 1 every year or paid on the 1^{st} of every month).

At step 230, method 200 determines an upcoming data processing transaction corresponding to the pattern of step 220. In some embodiments, the upcoming data processing transaction is an upcoming bill pay transaction (e.g., a bill to be paid within the next predetermined number of days). In some embodiments, step 230 includes determining an amount of the upcoming bill pay transaction (e.g., $75) and a date associated with the upcoming bill pay transaction (e.g., to be paid in two days on February 1).

At step 240, method 200 compares the upcoming data processing transaction to a data item associated with the first account in order to determine if an amount of the upcoming data processing transaction is greater than a balance of the first account. In some embodiments, the data item is a current balance of the first account. In other embodiments, the data item is a predicted balance of the first account for a certain date in the future. If the amount of the upcoming data processing transaction is greater than the balance of the first account, method 200 proceeds to step 260. Otherwise, if the amount of the upcoming data processing transaction is less than or equal to the balance of the first account, method 200 proceeds to step 250.

At step 250, method 200 transacts the upcoming data processing transaction determined in step 230 using the first communications channel. In some embodiments, step 250 includes transferring funds from an internal account 112 to second computing system 120 using first M2M communications channel 160 (e.g., in order to pay a bill to a vendor associated with second computing system 120). After step 250, method 200 may end.

At step 260, method 200 determines a second communications channel between the second computing system and a third computing system. In some embodiments, the third computing system is third computing system 130. In some embodiments, the second communications channel is second M2M communications channel 170. At step 270, method 200 transacts the upcoming data processing transaction determined in step 230 using the second communications channel of step 260. In some embodiments, step 270 includes transferring funds from an external account 132 to second computing system 120 using first M2M communications channel 170 (e.g., in order to pay a bill to a vendor associated with second computing system 120). After step 270, method 200 may end.

FIG. 3 illustrates an example of computing components 300, in accordance with certain embodiments. The computing components 300 may be used to implement any of the structures illustrated in FIG. 1, or one or more portions thereof, such as network 105, user device 140, first computing system 110, second computing system 120, and/or third computing system 130. The computing components 300 may comprise any suitable hardware and/or software configured to perform the functionality described above. The computing components 300 may be implemented using shared hardware or separate hardware. In certain embodiments, computing components 300 may be distributed in a cloud network environment.

In certain embodiments, the components comprise one or more interface(s) 302, processing circuitry 304, and/or memory(ies) 306. In general, processing circuitry 304 controls the operation and administration of a structure by processing information received from memory 306 and/or interface 302. Memory 306 stores, either permanently or temporarily, data or other information processed by processing circuitry 304 or received from interface 302. Interface 302 receives input, sends output, processes the input and/or output and/or performs other suitable operations. An interface 302 may comprise hardware and/or software.

Examples of interfaces 302 include user interfaces, network interfaces, and internal interfaces. Examples of user interfaces include one or more graphical user interfaces (GUIs), buttons, microphones, speakers, cameras, and so on. Network interfaces receive information from or transmit information through a network, perform processing of information, communicate with other devices, or any combination of the preceding. Network interfaces may comprise any port or connection, real or virtual, wired or wireless, including any suitable hardware and/or software, including protocol conversion and data processing capabilities, to communicate through a LAN, WAN, or other communication system that allows processing circuitry 304 to exchange information with or through a network. Internal interfaces receive and transmit information among internal components of a structure.

Processing circuitry 304 communicatively couples to interface(s) 302 and memory 306, and includes any hardware and/or software that operates to control and process information. Processing circuitry 304 may include a programmable logic device, a microcontroller, a microprocessor, any suitable processing device, or any suitable combination of the preceding. Processing circuitry 304 may execute logic stored in memory 306. The logic is configured to perform functionality described herein. In certain embodiments, the logic is configured to perform the method described with respect to FIG. 2.

Memory 306 includes any one or a combination of volatile or non-volatile local or remote devices suitable for storing information. For example, memory comprises any suitable non-transitory computer readable medium, such as Read Only Memory (“ROM”), Random Access Memory (“RAM”), magnetic storage devices, optical storage devices, or any other suitable information storage device or a combination of these devices. Memory 306 may be local/integrated with the hardware used by processing circuitry 304 and/or remote/external to the hardware used by processing circuitry 304.

The scope of this disclosure is not limited to the example embodiments described or illustrated herein. The scope of this disclosure encompasses all changes, substitutions, variations, alterations, and modifications to the example embodiments described or illustrated herein that a person having ordinary skill in the art would comprehend.

Modifications, additions, or omissions may be made to the systems and apparatuses described herein without departing from the scope of the disclosure. The components of the systems and apparatuses may be integrated or separated. Moreover, the operations of the systems and apparatuses may be performed by more, fewer, or other components. Additionally, operations of the systems and apparatuses may be performed using any suitable logic comprising software, hardware, and/or other logic.

Modifications, additions, or omissions may be made to the methods described herein without departing from the scope of the disclosure. The methods may include more, fewer, or other steps. Additionally, steps may be performed in any suitable order. That is, the steps of any method disclosed herein do not have to be performed in the exact order disclosed, unless explicitly stated.

As used in this document, “each” refers to each member of a set or each member of a subset of a set. Furthermore, as used in the document “or” is not necessarily exclusive and, unless expressly indicated otherwise, can be inclusive in certain embodiments and can be understood to mean “and/or.” Similarly, as used in this document “and” is not necessarily inclusive and, unless expressly indicated otherwise, can be inclusive in certain embodiments and can be understood to mean “and/or.” All references to “a/an/the element, apparatus, component, means, step, etc.” are to be interpreted openly as referring to at least one instance of the element, apparatus, component, means, step, etc., unless explicitly stated otherwise.

Furthermore, reference to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

Although several embodiments have been illustrated and described in detail, it will be recognized that substitutions and alterations are possible without departing from the spirit and scope of the present disclosure, as defined by the appended claims.

1. A system comprising memory operable to store instructions and processing circuitry operable to execute the instructions, whereby the system is operable to:
access a plurality of previous data processing transactions associated with a first account of a user, wherein at least one of the plurality of previous data processing transactions are transacted using a first communications channel between a first computing system and a second computing system;
determine, using machine learning, a pattern from the plurality of previous data processing transactions associated with the first account;
determine an upcoming data processing transaction corresponding to the pattern;
compare the upcoming data processing transaction to a data item associated with the first account;
determine a second communications channel between the second computing system and a third computing system; and
transact, based on the comparison of the upcoming data processing transaction to the data item, the upcoming data processing transaction using a selected one of either the first communications channel or the second communications channel.

2. The system of claim 1, wherein the data item comprises:
a current balance of the first account; or
a predicted balance of the first account.

3. The system of claim 1, wherein transacting the upcoming data processing transaction using either the first communications channel or the second communications channel comprises utilizing machine-to-machine communications.

4. The system of claim 1, wherein:
the data item is a balance of the first account; and
comparing the upcoming data processing transaction to the data item comprises determining whether an amount of the upcoming data processing transaction is greater than the balance of the first account.

5. The system of claim 4, wherein transacting the upcoming data processing transaction using either the first communications channel or the second communications channel comprises:
transacting the upcoming data processing transaction using the first communications channel when the amount of the upcoming data processing transaction is less than or equal to the balance of the first account; and
transacting the upcoming data processing transaction using the second communications channel when the amount of the upcoming data processing transaction is greater than the balance of the first account.

6. The system of claim 1, wherein:
the plurality of previous data processing transactions comprises a plurality of bill pay transactions; and
the upcoming data processing transaction is an upcoming bill pay transaction.

7. The system of claim 1, wherein:
the first computing system is associated with the first account of the user, the first account comprising a checking or savings account;
the second computing system is associated with a second account of the user, the second account comprising an account of a bill to be paid; and
the third computing system is associated with a third account of the user, the third account comprising:
an online payment account;
a mobile payment account; or
a retirement account.

8. A method comprising:
accessing a plurality of previous data processing transactions associated with a first account of a user, wherein at least one of the plurality of previous data processing transactions are transacted using a first communications channel between a first computing system and a second computing system;
determining, using machine learning, a pattern from the plurality of previous data processing transactions associated with the first account;
determining an upcoming data processing transaction corresponding to the pattern;
comparing the upcoming data processing transaction to a data item associated with the first account;
determining a second communications channel between the second computing system and a third computing system; and
transacting, based on the comparison of the upcoming data processing transaction to the data item, the upcoming data processing transaction using a selected one of either the first communications channel or the second communications channel.

9. The method of claim 8, wherein the data item comprises:
a current balance of the first account; or
a predicted balance of the first account.

10. The method of claim 8, wherein transacting the upcoming data processing transaction using either the first communications channel or the second communications channel comprises utilizing machine-to-machine communications.

11. The method of claim 8, wherein:
the data item is a balance of the first account; and
comparing the upcoming data processing transaction to the data item comprises determining whether an amount of the upcoming data processing transaction is greater than the balance of the first account.

12. The method of claim 11, wherein transacting the upcoming data processing transaction using either the first communications channel or the second communications channel comprises:
transacting the upcoming data processing transaction using the first communications channel when the amount of the upcoming data processing transaction is less than or equal to the balance of the first account; and
transacting the upcoming data processing transaction using the second communications channel when the amount of the upcoming data processing transaction is greater than the balance of the first account.

13. The method of claim 8, wherein:
the plurality of previous data processing transactions comprises a plurality of bill pay transactions; and
the upcoming data processing transaction is an upcoming bill pay transaction.

14. The method of claim 8, wherein:
the first computing system is associated with the first account of the user, the first account comprising a checking or savings account;
the second computing system is associated with a second account of the user, the second account comprising an account of a bill to be paid; and
the third computing system is associated with a third account of the user, the third account comprising:
an online payment account;
a mobile payment account; or
a retirement account.

15. A non-transitory computer readable medium comprising logic that, when executed by processing circuitry, causes the processing circuitry to perform actions comprising:
accessing a plurality of previous data processing transactions associated with a first account of a user, wherein at least one of the plurality of previous data processing transactions are transacted using a first communications channel between a first computing system and a second computing system;
determining, using machine learning, a pattern from the plurality of previous data processing transactions associated with the first account;
determining an upcoming data processing transaction corresponding to the pattern;
comparing the upcoming data processing transaction to a data item associated with the first account;
determining a second communications channel between the second computing system and a third computing system; and
transacting, based on the comparison of the upcoming data processing transaction to the data item, the upcoming data processing transaction using a selected one of either the first communications channel or the second communications channel.

16. The non-transitory computer readable medium of claim 15, wherein the data item comprises:
a current balance of the first account; or
a predicted balance of the first account.

17. The non-transitory computer readable medium of claim 15, wherein transacting the upcoming data processing transaction using either the first communications channel or the second communications channel comprises utilizing machine-to-machine communications.

18. The non-transitory computer readable medium of claim 15, wherein:
the data item is a balance of the first account;
comparing the upcoming data processing transaction to the data item comprises determining whether an amount of the upcoming data processing transaction is greater than the balance of the first account; and
transacting the upcoming data processing transaction using either the first communications channel or the second communications channel comprises:
transacting the upcoming data processing transaction using the first communications channel when the amount of the upcoming data processing transaction is less than or equal to the balance of the first account; and
transacting the upcoming data processing transaction using the second communications channel when the amount of the upcoming data processing transaction is greater than the balance of the first account.

19. The non-transitory computer readable medium of claim 15, wherein:
the plurality of previous data processing transactions comprises a plurality of bill pay transactions; and
the upcoming data processing transaction is an upcoming bill pay transaction.

20. The non-transitory computer readable medium of claim 15, wherein:
the first computing system is associated with the first account of the user, the first account comprising a checking or savings account;
the second computing system is associated with a second account of the user, the second account comprising an account of a bill to be paid; and
the third computing system is associated with a third account of the user, the third account comprising:
an online payment account;
a mobile payment account; or
a retirement account.
